(19) United States
(12) Patent Application Publication
(10) Pub. No.: US 2007/0285675 A1
(43) Pub. Date: Dec. 13, 2007

(54) Image processing apparatus and data cloning method

(75) Inventors: Mikiya Okada, Nara (JP); Yohichi Kimura, Nara (JP); Kunihisa Chiba, Osaka (JP); Yoshimune Noda, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/713,315

(22) Filed: Mar. 2, 2007

(30) Foreign Application Priority Data
Mar. 28, 2006 (JP) 2006-088787

(51) Int. Cl. G06F 15/00

(52) U.S. Cl. 358/1.1

(57) ABSTRACT

A setting data selecting portion selects setting data for each function according to user input to an operation input portion, the setting data being used to set various preset values related to functions of the image processing apparatus. An image forming portion forms setting data selected by the setting data selecting portion into an image on a recording medium to make a clone sheet. A data setting portion sets setting data, which is read from a clone sheet by an image reading portion, on the image processing apparatus into which the data setting portion is incorporated, the set data being the setting data related to corresponding functions. This setting data may include setting data selected out of prepared selection items, setting data set by user input, type information of the image processing apparatus, and log information of the image processing apparatus.

### CROSS-NOTING PARAGRAPH

This Non-provisional application claims priority under 35 U.S.C. §119 (a) on Patent Application No. 2006-088787 filed in JAPAN on Mar. 28, 2006, the entire contents of which are hereby incorporated herein by reference.

### FIELD OF THE INVENTION

The present invention relates generally to an image processing apparatus and a data cloning method, and more particularly, to an image processing apparatus having a function of transplanting (cloning) preset values related to various functions of the image processing apparatus to another image processing apparatus, and a cloning method.

### BACKGROUND OF THE INVENTION

Various types of image processing apparatuses have been known, which include a scanner that transfers image data obtained by reading a document to another apparatus via a public network, etc., a copier that records image data obtained by reading a document on a recording material, and a multi-function peripheral that combines a copier function, a fax machine function, and a printer function.

According to such an image processing apparatus, various conditions for executing functions of the image processing apparatus are set on the apparatus. For example, many setting items, such as paper size, double-face copy, magnification/demagnification, copy density, and tray, are present for a copying function.

In a multi-function peripheral, which has a multiple of functions of faxing, printing, etc., various setting items are present for each function.

In determining a preset value for a setting item for each function, a need of determining a preset value common to a plurality of image processing apparatuses may arise.

For example, in a manufacturing process for an image processing apparatus, changing a preset value to a common value to a specific lot may be required. In another case, where a number of image processing apparatuses are delivered to the same customer, setting a common preset value original to the customer on each image processing apparatus may be required.

In such a case, information of a preset value set on one image processing apparatus must be transplanted to each image processing apparatus requiring the information. This transplantation is called cloning.

In an image processing apparatus having functions of faxing, e-mail transmission/reception, etc., user input information is set on an address note, etc., which information includes contacting party names, phone numbers, fax numbers, e-mail addresses, group entry information, and index information.

For example, when common address information is used in the same office, such user input information may also need to be cloned on a plurality of image processing apparatuses.

Related to a technique that allows another image processing apparatus to use such an input preset value of one image processing apparatus, for example, Japanese Laid-Open Patent Publication No. H11-266361 discloses an image processing apparatus that efficiently carries out delicate adjustment of image quality and that allows another image processing apparatus to use image input setting made by one image processing apparatus.

According to the disclosed image processing apparatus, a personal computer is connected to a scanner via a communication cable to carry out image reading work. When a document is read using a variety of parameters for reading, a setting entry portion stores setting contents on image reading in a history recording portion, after which the stored history information is put on a display. An operator, therefore, is allowed to adjust parameters so that not only the setting contents just before the image reading but also the past contents are read out to enable the image processing apparatus to take in an image of a better quality.

Conventionally, when preset value information for each function set on an image processing apparatus and user input preset values set on an address note, etc., are cloned on another image processing apparatus, for example, preset values are needed to be cloned on another image processing apparatus via a serial interface, or on each image processing apparatus via a serial interface and a PC or via a network and a server in carrying out cloning work.

Connecting image processing apparatuses via an interface and cloning preset values one by one is, however, extremely cumbersome work.

Besides, a low-performance apparatus that cannot be connected to an interface cannot clone the preset values via the interface. Also, when a preset value related to each function is set in a mounting process for each function unit on a production line of an image processing apparatus, preset value cloning via the above interface becomes difficult.

The technique disclosed in Japanese Laid-Open Patent Publication No. H11-266361 allows an alteration in setting of various parameters through the use of stored history information, but it does not disclose an idea that enables easy preset value cloning on an apparatus in a manufacturing process, an apparatus incapable of interface connection, etc.

### SUMMARY OF THE INVENTION

The object of the present invention is to provide an image processing apparatus that allows various preset values for each function of the image processing apparatus and user input preset values to be cloned surely and easily between image processing apparatuses without a need of interconnecting the image processing apparatuses via an interface.

Another object of the present invention is to provide an image processing apparatus comprising an image reading portion that reads an image recorded on a recording medium and an image forming portion that forms an image on a recording medium, wherein the image processing apparatus further includes a setting data selecting portion that selects setting data for each function according to user input, the setting data being used to set various preset values related to functions of the image processing apparatus, and wherein the image forming portion forms setting data selected by the setting data selecting portion into an image on a recording medium.

Another object of the present invention is to provide the image processing apparatus, further including a data setting portion that clones a preset value by setting the setting data read by the image reading portion on the image processing apparatus.

Another object of the present invention is to provide the image processing apparatus, wherein the setting data include setting data selected out of prepared selection items and setting data set by user input.

Another object of the present invention is to provide the image processing apparatus, wherein the image forming portion forms type data of the image processing apparatus, together with the setting data, into an image, the type data being used to determine on appropriateness of cloning.

Another object of the present invention is to provide the image processing apparatus, wherein the image forming portion forms log data, together with the setting data, into an image, the log data indicating a process status of the image processing apparatus.

Another object of the present invention is to provide the image processing apparatus, wherein the image forming portion forms any one or plurality of the setting data, type data, and log data into an image of coded information, the type data being used to determine on appropriateness of cloning a preset value, and the log data indicating a process status of the image processing apparatus.

Another object of the present invention is to provide the image processing apparatus, wherein the image forming portion forms any one or plurality of the setting data, the type data, and the log data into an image of character information.

Another object of the present invention is to provide a cloning method for cloning setting data between image processing apparatuses each having an image forming portion that forms an image on a recording medium according to an image read by an image reading portion, the setting data being used to set various preset values related to functions of the image processing apparatus, the method comprising: a setting data selecting step of selecting the setting data for each function of the image processing apparatus according to user input; and an image forming step of forming the setting data selected at the setting data selecting step into an image on a recording medium.

Another object of the present invention is to provide the cloning method, further including a cloning step of setting the setting data read by the image forming portion on the image processing apparatus to execute cloning.

Another object of the present invention is to provide the cloning method, wherein the setting data include setting data selected out of prepared selection items and setting data set by user input.

Another object of the present invention is to provide the cloning method, wherein at the image forming step, type data of the image processing apparatus, together with the setting data, is formed into an image, the type data being used to determine on appropriateness of cloning.

Another object of the present invention is to provide the cloning method, wherein at the image forming step, log data, together with the setting data, is formed into an image, the log data indicating a process status of the image processing apparatus.

Another object of the present invention is to provide the cloning method, wherein at the image forming step, any one or plurality of the setting data, type data of the image processing apparatus, and log data is or are formed into an image of coded information, the type data being used to determine on appropriateness of cloning a preset value, and the log data indicating a process status of the image processing apparatus.

Another object of the present invention is to provide the cloning method, wherein at the image forming step, any one or plurality of the setting data, the type data, and the log data is or are formed into an image of character information.

### BRIEF DESCRIPTION OF THE DRAWINGS

FIG. 1 is an explanatory view of a structural example of a digital multi-function peripheral to which an image processing apparatus of the present invention is applicable;

FIG. 2 is a functional block diagram for explaining functions of the image processing apparatus of the present invention;

FIG. 3 depicts an example of an operation portion of the digital multi-function peripheral shown in FIG. 1;

FIG. 4 is an explanatory view of a setting example of preset values for a copy mode function;

FIG. 5 depicts a screen that appears when a binding margin key shown in FIG. 4 is pressed;

FIG. 6 depicts a screen that appears when a middle binding key shown in FIG. 4 is pressed;

FIG. 7 depicts a screen that appears when a multi-shot key shown in FIG. 4 is pressed;

FIG. 8 depicts a screen that appears when a copy density key on a screen shown in FIG. 3 is pressed;

FIG. 9 depicts a screen that appears when a magnification factor key on the screen shown in FIG. 3 is pressed;

FIG. 10 depicts a screen that appears when a paper size key on the screen shown in FIG. 3 is pressed;

FIG. 11 depicts a screen that appears when a double face copy key shown in FIG. 3 is pressed;

FIG. 12 depicts a screen that appears when a user setting key shown in FIG. 3 is pressed;

FIG. 13 depicts a screen that appears when a contacting party entry key shown in FIG. 12 is pressed;

FIG. 14 depicts a screen that appears when a contacting party address key shown in FIG. 13 is pressed;

FIG. 15 depicts a screen that appears when a one-touch key shown in FIG. 14 is pressed;

FIG. 16 depicts a screen of an address note that appears when a fax/image transmission key shown in FIG. 3 is pressed;

FIG. 17 depicts another screen of an address note that appears when the fax/image transmission key shown in FIG. 3 is pressed;

FIGS. 18A to 18C are explanatory views of an example of authentication for access to a key operator program on a user setting screen;

FIG. 19 depicts an example of a menu screen of the key operator program;

FIG. 20 depicts a device setting screen that appears when a device setting key is pressed on the screen shown in FIG. 19;

FIG. 21 depicts a security setting screen that appears when a security setting key shown in FIG. 20 is pressed;

FIG. 22 depicts the same example of menu screen of the key operator program shown in FIG. 19;

FIG. 23 depicts a system management setting screen that appears when a system management setting key is pressed on the menu screen of the key operator program;

FIG. 24 depicts a network setting screen that appears when a network setting key is pressed on the system management setting screen shown in FIG. 23;

FIG. 25 depicts an IP address setting screen that appears when an IP address setting key shown in FIG. 24 is pressed;

FIG. 26 depicts a state of selection of a clone process key on the menu screen of key operator program shown in FIG. 22;

FIG. 27 depicts a clone process menu screen that appears when the clone process key is pressed on the screen shown in FIG. 26;

FIG. 28 depicts a screen that appears when a clone list making key is pressed on the clone process menu screen shown in FIG. 27;

FIG. 29 depicts another screen that appears when the clone list making key is pressed on the clone process menu screen shown in FIG. 27;

FIG. 30 is a schematic diagram of an example of a clone list made by a clone list making process;

FIG. 31 is a schematic diagram of another example of a clone list made by the clone list making process;

FIG. 32 depicts a state of selection of a clone list reading key on the clone process menu screen shown in FIG. 27;

FIG. 33 depicts a clone list reading start screen that appears when clone list reading is brought into effect on the screen shown in FIG. 32;

FIG. 34 depicts an example of log data of the digital multi-function peripheral, which is an example of a print job management list that is one piece of log information;

FIG. 35 depicts an example of log data of the digital multi-function peripheral, which is an example of a table that records the operation contents of each job on the basis of the print job management list shown in FIG. 34; and

FIG. 36 is a flowchart for explaining an example of the clone process according to the present invention.

### PREFERRED EMBODIMENTS OF THE INVENTION

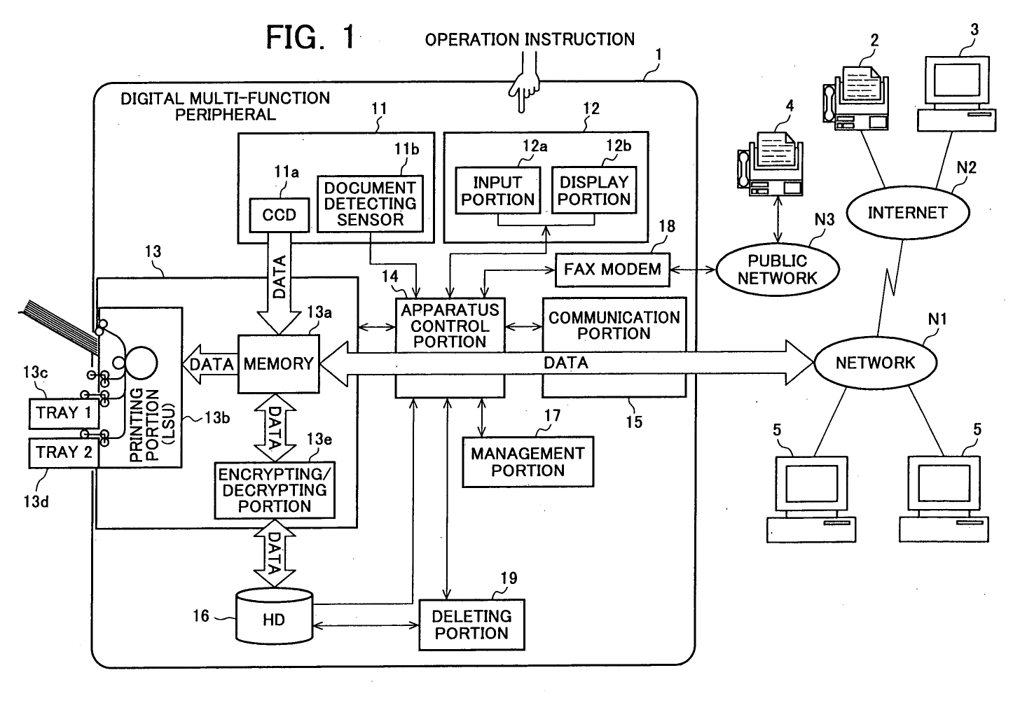

FIG. 1 is an explanatory view of a structural example of a digital multi-function peripheral to which an image processing apparatus of the present invention is applicable. An embodiment according to the present invention will now be described referring to the digital multi-function peripheral 1. The image processing apparatus of the present invention is applicable to various types of image processing apparatuses, each of which has an image reading portion, such as scanner, that reads an image recorded on a recording medium, and an image forming portion that forms an image on a recording medium by printing, etc.

The digital multi-function peripheral 1 comprises an apparatus control portion 14 including a CPU which performs arithmetic operations and a RAM and the like which store temporal information in association with the operations. A ROM which stores a control program for controlling the digital multi-function peripheral 1 is included in the apparatus control portion 14. A management portion 17 which is a memory storing management information (various items of control information) for managing the processing conducted by the digital multi-function peripheral 1 is connected to the apparatus control portion 14.

An image reading portion 11 which reads images recorded on the recording paper to generate image data is connected to the apparatus control portion 14. The image reading portion 11 is provided with a CCD 11a for reading document images as image data and a document detecting sensor 11b which detects the presence or absence of the document.

An image forming portion 13 which forms image data on recording paper is connected to the apparatus control portion 14. The image forming portion 13 is provided with a memory 13a for temporarily storing the image data, a printing portion (LSU) 13b which forms images from the image data stored by the memory 13a for recording them on recording paper, paper trays 13c, 13d from which recording paper is fed for the image formation at the printing portion 13b, and an encrypting/decrypting portion 13e which conducts an encrypting or decrypting process to the image data.

The digital multi-function peripheral 1 causes the memory 13a to temporarily store the image data generated by the image reading portion 11, after which the printing portion 13b forms an image. The image data stored temporarily in the memory 13a may be encrypted at the encrypting/decrypting portion 13e and then stored in a hard disc (HD) 16. In such a case, the image data read out of the HD 16 is decrypted at the encrypting/decrypting portion 13e and is read into the memory 13a to allow transmission of the image data to the printing portion 13b. In this manner, the digital multi-function peripheral 1 functions as a copier.

The ROM of the apparatus control portion 14 retains a two-dimensional code program for coding various setting data, log data, etc., into two-dimensional codes and decoding coded information. Following the two-dimensional code program, the apparatus control portion 14 codes selected setting data, log data, etc., to generate two-dimensional codes, and decodes two-dimensional codes read by the image reading portion 11 to obtain these setting data and log data.

When a code other than a two-dimensional code is employed as the coded information of setting data and log data, the ROM retains a program that enables coding/decoding of the employed code.

The apparatus control portion 14 is connected to a fax modem 18 carrying out fax communication, which fax modem 18 is connected to a public network N3.

The digital multi-function peripheral 1 can transmit image data, which is generated by the image reading portion 11 or obtained from an external apparatus and is stored in the memory 13a or HD 16, to another fax machine 4 by fax via the public network N3 connected to the fax modem 18. In this manner, the digital multi-function peripheral 1 offers a scan-to-fax function.

The digital multi-function peripheral 1 can receive image data, which is transmitted to the multi-function peripheral 1 from another fax machine 4 via the public network N3, at the fax modem 18, and form an image at the image forming portion 13. In this manner, the digital multi-function peripheral 1 functions as a fax machine.

A communication portion (transceiver portion) 15 which enables the digital multi-function peripheral 1 to transmit/receive information to/from an external apparatus is connected to the apparatus control portion 14. The communication portion 15 can be connected to a communication network N1 such as intra-LAN and the like. A plurality of personal computers (PC) 5 can be connected to the communication network N1.

In a usual situation at which the digital multi-function peripheral 1 is operated alone, the communication portion 15 is connected to the communication network Ni for exchanging information with PC(s) 5 via the communication network N1.

The digital multi-function peripheral 1 is capable of transmitting image data which is generated by the image reading portion 11 to PC 5 from the communication portion 15. Thus, the digital multi-function peripheral 1 functions as a network scanner. In case of storing the generated image data in the HD 16, the digital multi-function peripheral 1 functions as a scanner.

The digital multi-function peripheral 1 can receive image data transmitted from the PC 5 at the communication portion 15, and form an image at the image forming portion 13. In this manner, the digital multi-function peripheral 1 functions as a printer.

The communication network N1 is connected further to a wide area communication network N2, such as the Internet. The communication portion 15 is capable of transmitting/receiving image data to/from an Internet fax machine 2 and an external PC 3, which are connected to the wide area communication network N2. In this manner, the digital multi-function peripheral 1 functions as an Internet fax machine, and also functions as an e-mail transmitting apparatus that transmits an e-mail attached with image data and as a data transmitting apparatus that transmits image data according to FTP (File Transfer Protocol).

The apparatus control portion 14 is connected to an operation portion 12 that receives an operation instruction from a user. The operation portion 12 comprises an input portion 12a composed of a touch panel, numeric keys, etc., to which such information as a control command is input by the user's operation, and a display portion 12b composed of a liquid crystal panel, etc., which displays information necessary for operation.

To the operation portion 12, an authentication code for authenticating the administrator or user (i.e., operator) of the digital multi-function peripheral 1 is input. The authentication code may be input from an external device via the fax modem 18 or the communication portion 15. The apparatus control portion 14 is connected also to a deleting portion 19 that deletes data recorded/stored in the HD 16.

The embodiment according to the present invention gives the digital multi-function peripheral 1 a feature that the multi-function peripheral 1 forms various setting data related to functions of the multi-function peripheral 1 and user input setting data into images on a recording medium, such as recording paper, where preset values can be coded into two-dimensional codes, etc.

Another digital multi-function peripheral 1 reads the preset value data from the recording paper bearing the coded information formed into the images. Another multi-function peripheral 1 then decodes the preset value data when it is coded, and sets various setting data, which are obtained by decoding, for the corresponding functions of another digital multi-function peripheral 1. In this manner, cloning of various setting data can be carried out easily between a plurality of digital multi-function peripherals 1 through the recording medium. In addition to the above setting data, the multi-function peripheral 1 also forms type data and log data of an image processing apparatus into images to enable cloning of those data.

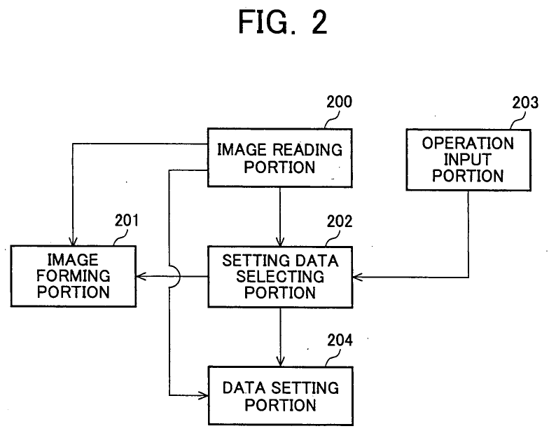

FIG. 2 is a functional block diagram for explaining functions of the image processing apparatus of the present invention. An image reading portion 200 reads an image recorded on a recording medium, such as recording paper. The image reading portion 200 is equivalent to the image reading portion 11 of the digital multi-function peripheral 1 shown in FIG. 1.

An image forming portion 201 forms an image on a recording medium, such as recording paper, according to the image read by the image reading portion 200. The image forming portion 201 is equivalent to the image forming portion 13 of the digital multi-function peripheral 1 shown in FIG. 1.

A setting data selecting portion 202 selects setting data for each function, the setting data being used for setting various preset values related to functions of the image processing apparatus, according to user input to an operation input portion 203.

The setting data selecting portion 202 is equivalent to the apparatus control portion 14 of the digital multi-function peripheral 1 shown in FIG. 1, and the operation input portion 203 is equivalent to the operation portion 12 shown in FIG. 1.

The image forming portion 201 can form setting data selected at the setting data selecting portion 202 into images on a recording medium to make a clone sheet.

A data setting portion 204 takes setting data on the clone sheet read by the image reading portion 200 to be the setting data related to the functions corresponding to the setting data in cloning, and sets the setting data on the image processing apparatus into which the data setting portion 204 incorporated. The data setting portion 204 is equivalent to the apparatus control portion 14 shown in FIG. 1.

The above setting data can include setting data selected from prepared selection items and setting data set by user input.

Upon making a clone sheet, the image forming portion 201 can form type data of the image processing apparatus, which is used for determining on the appropriateness of cloning, into an image, in addition to the image formation from the above setting data. Upon making the clone sheet, the image forming portion 201 can also form log data, which indicates the process status of the image processing apparatus, into an image, in addition to the image formation from the above setting data. Thus, the image forming portion 201 can form any one or plurality of those setting data, type data, and log data into images in the form of coded information, or in the form of character information. The image forming portion 201 is equivalent to the image forming portion 13 and the apparatus control portion 14 having the coding program, which are shown in FIG. 1.

An embodiment of a cloning process according to the present invention will then be described in detail with reference to an example of a screen of the operation portion 12 of the digital multi-function peripheral 1.

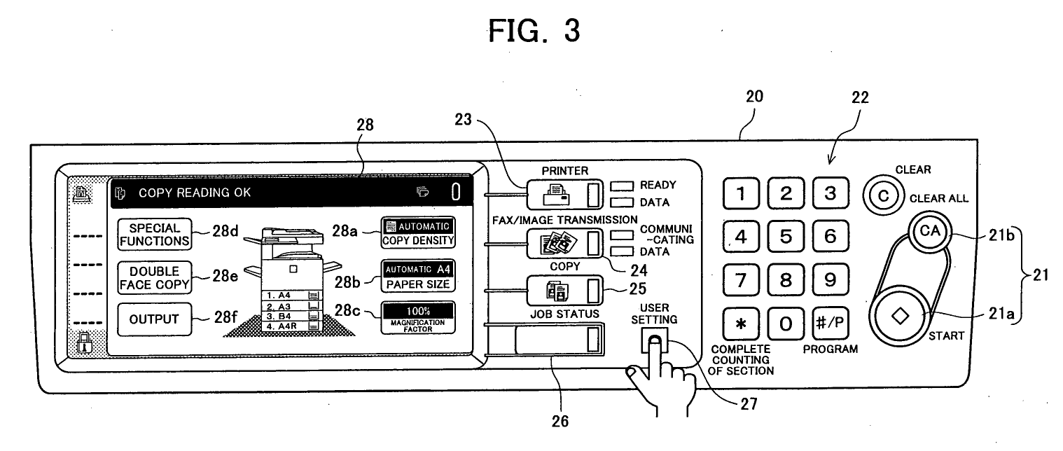

Examples of various preset values to be set on the digital multi-function peripheral 1 will first be described with reference to FIGS. 3 to 24.

FIG. 3 depicts an example of the operation portion of the digital multi-function peripheral shown in FIG. 1.

An operation panel 20 is equivalent to the input portion 12a and display portion 12b shown in FIG. 1. The operation panel 20 has a main key 21 composed of a start key 21a and a clear all key 21b. The operation panel 20 further includes numeric keys 22, a printer key 23, a fax/image transmission key 24, a copy key 25, a job status key 26, a user setting key 27, and a touch panel 28.

The printer key 23, fax/image transmission key 24, copy key 25, and job status key 26 are keys for displaying a GUI (Graphical User Interface) corresponding to each key on the touch panel 28.

The printer key 23 is used to change a screen display on the touch panel 28 into a printer mode screen. The fax/image transmission key 24 is used to display a screen of a network scanner mode or fax mode on the touch panel 28.

The copy key 25 is used to display a copy mode screen on the touch panel 28. The job status key 26 is used to display the present job status on the touch panel 28. A displayed job status includes a list of jobs that are reserved, in progress, or completed. The list on the screen allows a check on the contents of jobs, a shift in the printing order of reserved jobs, or a suspension of a specific job.

The user setting key 27 is the key for changing a display screen on the touch panel 28 to a user setting screen. On the user setting screen, the user can carry out entry, correction, or deletion of a user name and/or folder name for document filing, key operator program, printer environment setting, and other operation.

FIG. 3 depicts an example of a basic screen on the touch panel 28 in the copy mode. The basic screen in the copy mode displays a copy density key 28a for displaying/setting copy density, a paper size key 28b for displaying/setting paper selection, and a magnification factor key 28c for displaying/setting a copy magnification factor.

The basic screen also displays a special function key 28d for setting a special function of binding margin setting, frame deletion, mass document mode, tandem copy, etc., a double face copy key 28e for setting single-face/double-face copy, and an output key 28f for outputting a read image.

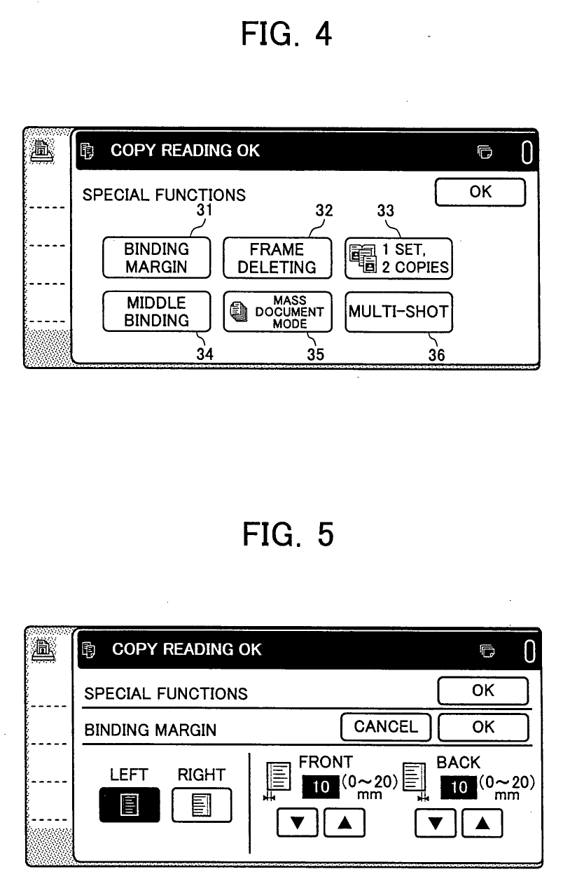

Each of FIGS. 4 to 7 is an explanatory view of a setting example of preset values for a copy mode function. Pressing the special function key 28d shown in FIG. 3 turns the screen into a screen shown in FIG. 4. An expression “pressing a key or button displayed on a screen” means touching a specific key or button on the touch panel to bring input into effect. Besides touching, the expression also means operation of selecting a key or button using a pointing device, direction key, etc., which is not shown, and bringing input to the key or button into effect.

The screen shown in FIG. 4 includes a binding margin key 31 for moving a document image to set a binding margin, a frame deleting key 32 for deleting a surrounding shadow that is formed when a thick document or book-type document is copied, a one-set-two-copy key 33 for copying the left/right halves of a document in series, a middle binding key 34 for putting a copy of two sheets of document on both front/back faces of one piece of paper and doubling the paper bearing the copies to make a middle binding booklet, a mass document mode key 35 for allowing split reading of documents that are too great in number to feed at once by an automatic document feeding function, and a multi-shot key 36 for setting intensive printing.

FIG. 5 depicts a screen that appears when the binding margin key 31 shown in FIG. 4 is pressed.

Using the binding margin key 31 causes the screen for binding margin setting to appear. In FIG. 5, a binding margin is set on the left side of recording paper, and the size of the binding margin is set to be 10 mm both on the front/back faces of the paper.

The above binding margin position and binding margin size are equivalent to one of pre-set values for the copy function. In the same manner as in the above case, various preset values are set in the following cases.

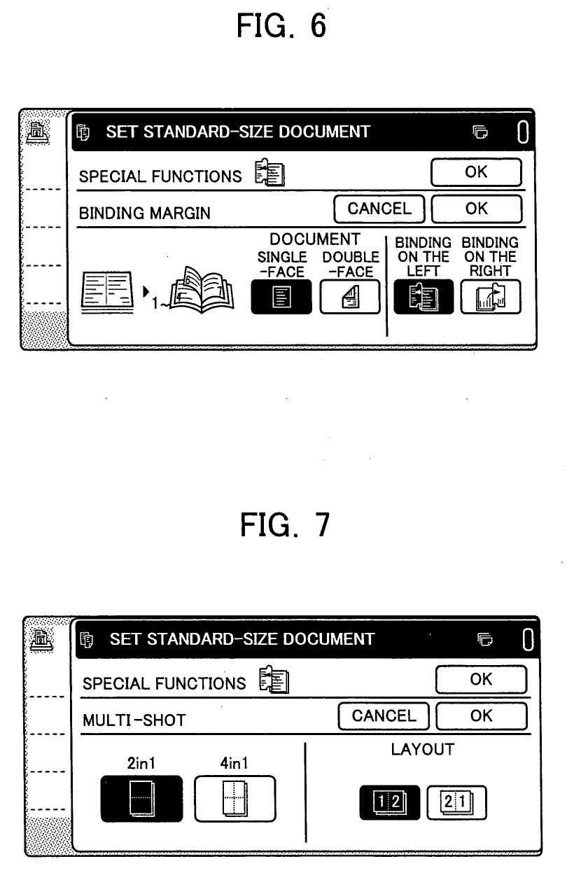

FIG. 6 depicts a screen that appears when the middle binding key 34 shown in FIG. 4 is pressed.

Using the middle binding key 34 causes the screen for middle binding setting to appear. In FIG. 6, a document is copied onto a single face of recording paper, and the recorded material is to be bound at the left side in a middle binding form.

FIG. 7 depicts a screen that appears when the multi-shot key 36 shown in FIG. 4 is pressed.

Using the multi-shot key 36 causes the screen for multi-shot (intensive printing) setting to appear. In FIG. 7, 2 in 1 intensive printing (two sheets of document are copied intensively onto one piece of recording paper) is set to be carried out to make a layout where the first sheet of document is printed on the left and the second sheet of document is printed on the right.

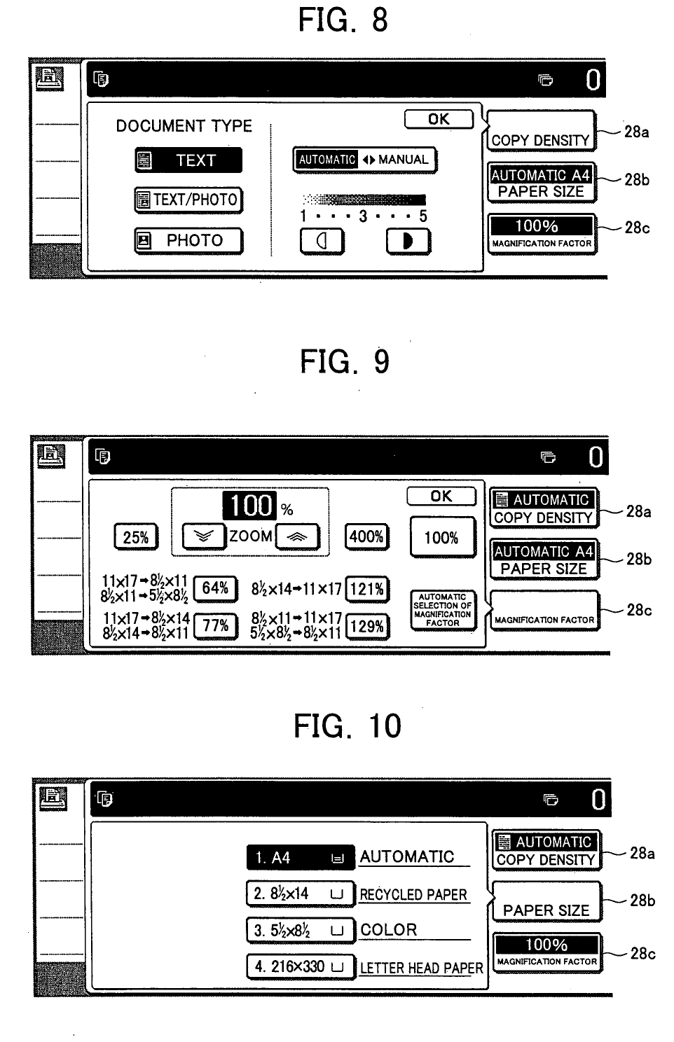

FIG. 8 depicts a screen that appears when the copy density key 28a on the screen shown in FIG. 3 is pressed. The copy density key 28a allows execution of copy density setting. In FIG. 8, the type of a document is set to be text, and copy density is set to be automatic.

FIG. 9 depicts a screen that appears when the magnification factor key 28c on the screen shown in FIG. 3 is pressed. The magnification factor key 28c allows copy magnification factor setting. In FIG. 9, automatic selection of 100% copy magnification factor is set.

FIG. 10 depicts a screen that appears when the paper size key 28b on the screen shown in FIG. 3 is pressed. The paper size key 28b allows paper size setting. In FIG. 10, automatic feeding of A4 size paper is set.

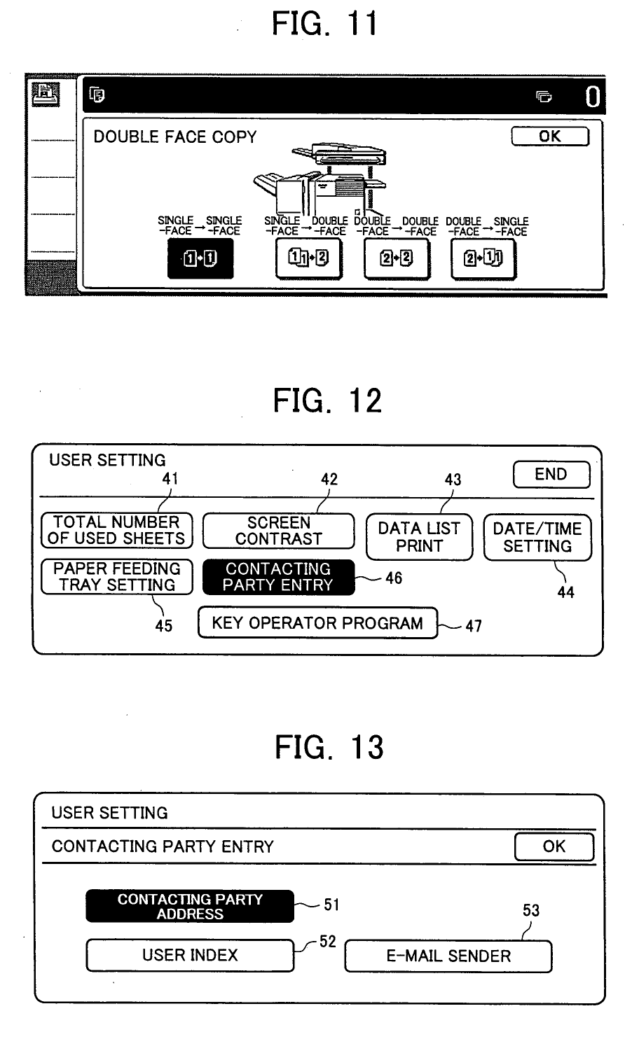

FIG. 11 depicts a screen that appears when the double face copy key 28e shown in FIG. 3 is pressed. The double face copy key 28e allows setting of a condition of single-face copy/double-face copy. In FIG. 11, single-face-to-single-face copy is set to copy a single-face document onto a single face of recording paper.

FIG. 12 depicts a screen that appears when the user setting key 27 shown in FIG. 3 is pressed.

Pressing the user setting key 27 shown in FIG. 3 causes a user setting screen shown in FIG. 12 to appear. The user setting screen displays setting item keys including total number of used sheets display 41, screen contrast 42, data list print 43, date/time setting 44, paper feeding tray setting 45, contacting party entry 46, and key operator program 47. The user is allowed to make setting for each item according to the setting item keys.

FIG. 13 depicts a screen that appears when the contacting party entry key 46 shown in FIG. 12 is pressed. The contacting party entry key 46 allows entry of a contacting party in communication by e-mail, Internet fax, etc.

The screen shown in FIG. 13 includes a contacting party address key 51, a user index key 52, and an e-mail sender key 53.

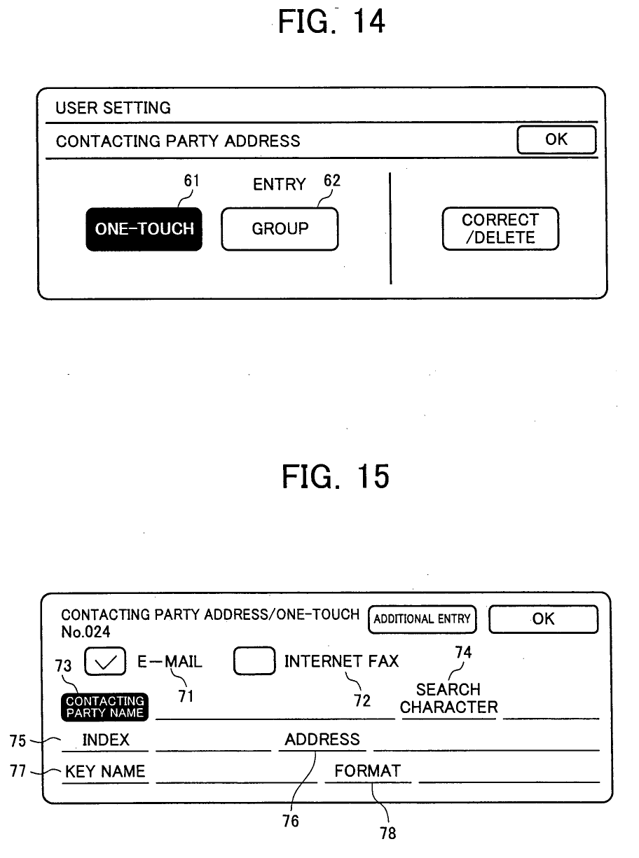

FIG. 14 depicts a screen that appears when the contacting party address key 51 shown in FIG. 13 is pressed. The contacting party address key 51 allows setting of the address of a contacting party in transmission.

The screen shown in FIG. 14 includes a one-touch key 61 and a group key 62.

FIG. 15 depicts a screen that appears when the one-touch key 61 shown in FIG. 14 is pressed.

Using the one-touch key 61 allows entry of the address of a contacting party in transmission by e-mail or Internet fax on a one-touch key.

On the screen shown in FIG. 15, an e-mail 71 and an Internet fax 72 are set as transmission means, which can be specified by checking each check box for the e-mail 71 and Internet fax 72 at will.

Pressing a contacting party name 73 changes the screen to a character input screen (not shown), where the name of a contacting party in transmission can be entered. Pressing a search character key 74 allows setting of hiragana for searching, where up to five hiragana characters can be set. Search characters, which are input to the search character key 74, determine the pattern of classification in a Japanese syllabary index and the order of displaying one-touch keys.

Pressing an index key 75 changes the screen to an index setting screen (not shown), where the index of a contacting party in transmission can be set. A user index can be set, which is different from an index employing a classification method according to the Japanese syllabary.

Pressing an address key 76 changes the screen to an address input screen (not shown), where the address of a contacting party in transmission can be input.

Pressing a key name key 77 changes the screen to a key name input screen (not shown), where the name of a key displayed on the one-touch key can be set.

Pressing a format key 78 changes the screen to a format setting screen (not shown), where the file format and compression format of data to be transmitted can be set.

Pressing the group key 62 shown in FIG. 14 puts a contacting party in transmission, which is entered on a one-touch key, in a group entry category.

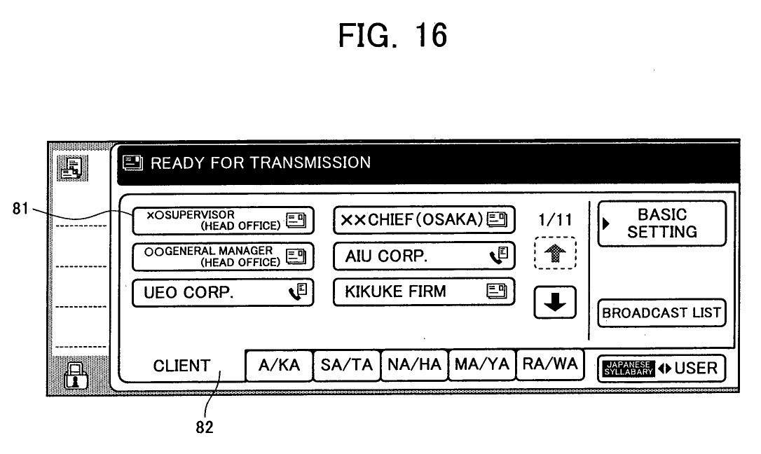

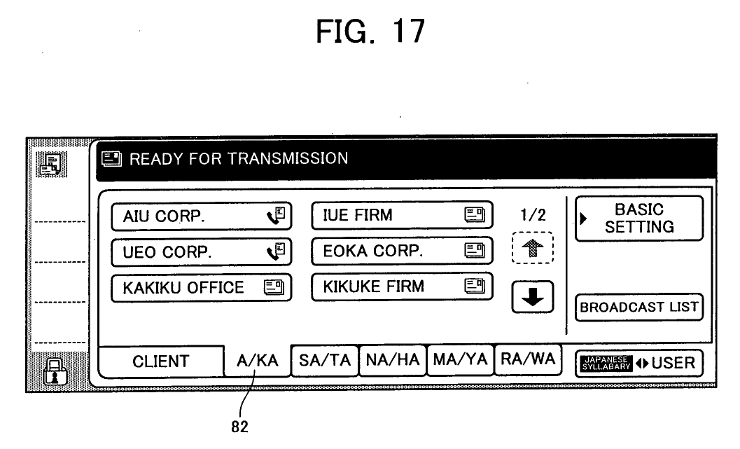

Each of FIGS. 16 and 17 depicts a screen of the address note that appears when the fax/image transmission key 24 shown in FIG. 3 is pressed. Using the fax/image transmission key 24 allows display of an address note screen, which shows contacting parties in transmission by the network scanner or fax, on the touch panel 28.

As shown in FIG. 16, contacting parties in transmission entered on one-touch keys 81 are displayed. These contacting parties are classified with indexes 82. An index “client” shown in FIG. 16 is an index that is set by a user in separation from a normal Japanese syllabary index. FIG. 17 depicts an example of contacting parties in transmission that are set to an index of “A/KA” in the address note shown in FIG. 16.

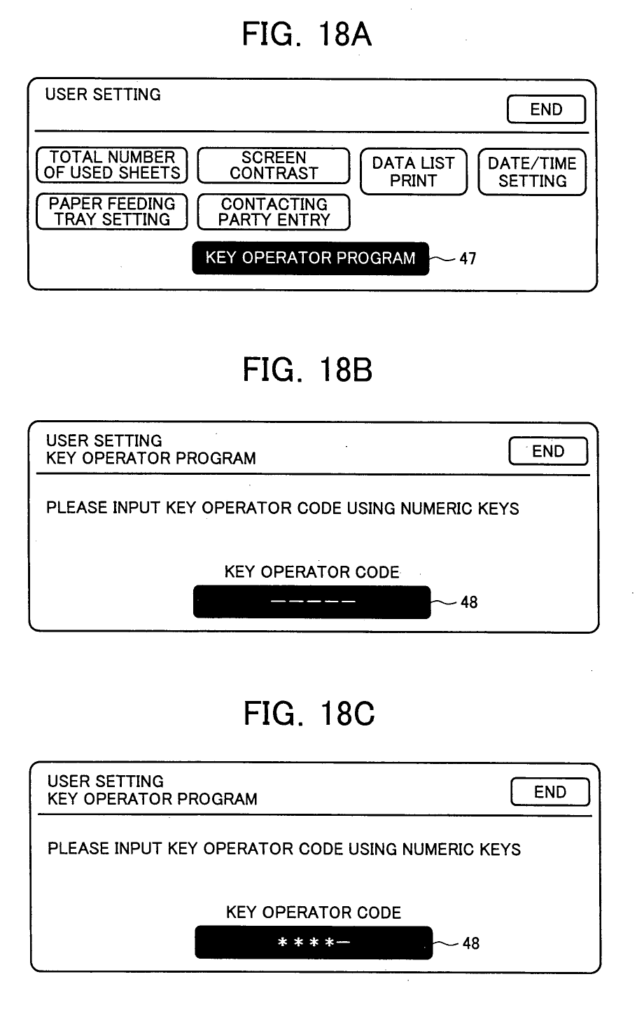

FIGS. 18A to 18C are explanatory views of an example of authentication for access to a key operator program on a user setting screen.

FIG. 18A depicts the same screen as the user setting screen shown in FIG. 12, showing a state of selection of the key operator program key 47. When the key operator program key 47 is pressed, a key operator code input screen shown in FIG. 18B appears. A key operator then inputs a given code to a key operator code input space 48 (FIG. 18C).

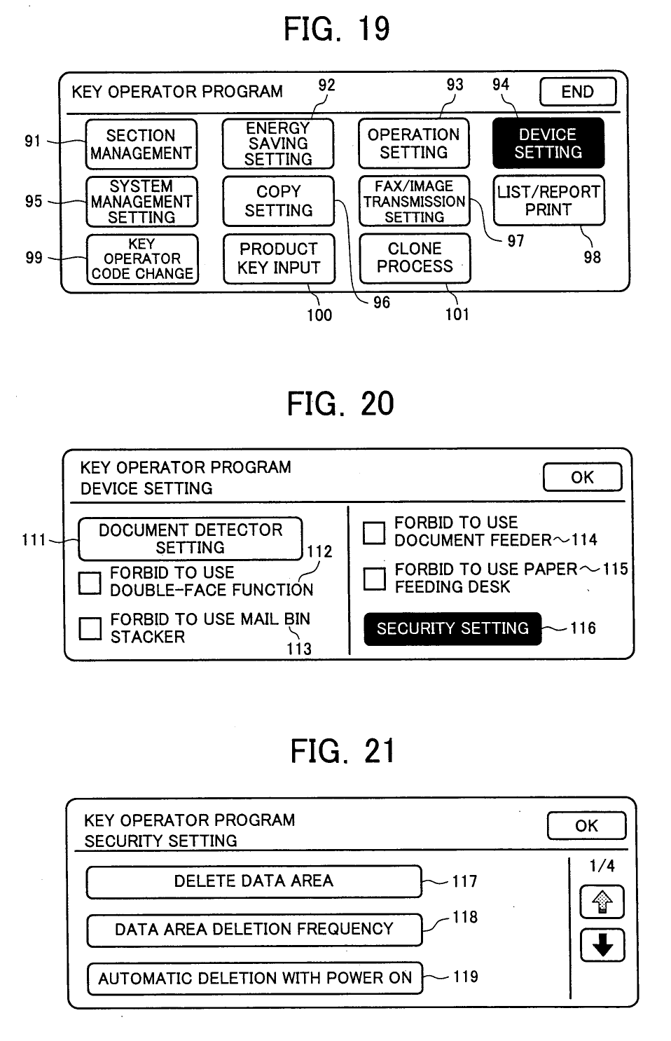

FIG. 19 depicts an example of a menu screen of the key operator program.

When a code input on the key operator code input screen shown in FIG. 18C is authenticated, a key operator program menu screen appears, as shown in FIG. 19.

The key operator program menu screen includes section management key 91 for setting the total number of sheets of paper, a limit to the number of sheets of paper to be used, etc., separately for each section, an energy-saving setting key 92 for making energy-saving setting for a save mode, etc., an operation setting key 93 for making setting on operation for a key touch sound, autoclear mode, etc., a device setting key 94 for setting a prohibition on use of peripheral apparatus, etc., and a system management setting key 95 for making various setting for system management on interfaces, networks, etc.

The key operator program menu screen further includes a copy setting key 96 for setting various copy conditions, such as copy density and magnification factor in the copy mode, a fax/image transmission setting key 97 for setting various conditions for fax transmission or image transmission, a list/report print key 98 for printing a list and/or report that can be printed only by the key operator, a key operator code change key 99 for changing a key operator code and/or registered number, a product key input key 100 for carrying out input operation on a product key (password), and a clone process key 101 according to the present invention.

FIG. 20 depicts a device setting screen that appears when the device setting key 94 is pressed on the screen shown in FIG. 19.

On the device setting screen, check box items are set as document detector setting 111, check box items including a double-face function use prohibition 112, a mail bin stacker use prohibition 113, a document feeder use prohibition 114, and a paper feeding desk use prohibition 115. Checking a check box item brings a function represented by the item into effect. By using these check box items, the user can make proper setting for suspension of a peripheral unit that is to be prohibited temporarily from being used, for example, when a peripheral unit connected to the main body is in trouble.

The device setting screen shown in FIG. 20 also includes a security setting key 116.

FIG. 21 depicts a security setting screen that appears when the security setting key 116 shown in FIG. 20 is pressed.

The security setting screen includes a data area deletion key 117 for deleting data in a data area, a data area deletion frequency key 118 for setting the frequency of deletion of the data area, and an automatic deletion with power on key 119 for setting automatic deletion of the data area when power is on.

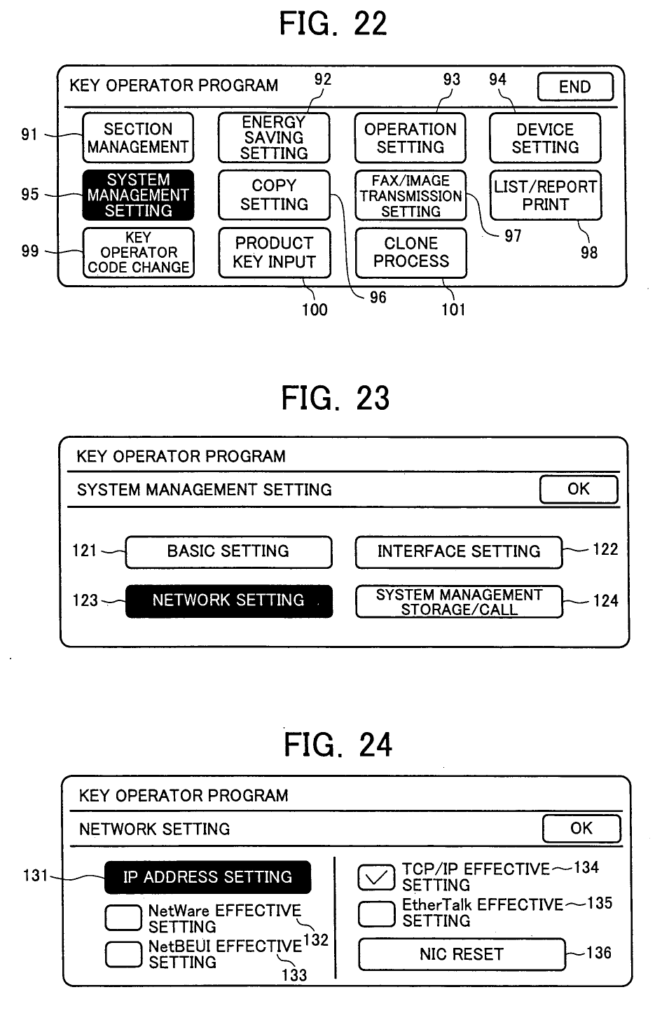

FIG. 22 depicts the same menu screen of the key operator program shown in FIG. 19, showing a state of selection of the system management setting key 95. FIG. 23 depicts a system management setting screen that appears when the system management setting key 95 is pressed on the menu screen of the key operator program.

The system management setting screen includes a basic setting key 121 for changing or canceling setting on various printer functions at the time of factory shipment, an interface setting key 122 for setting monitoring or limitation on data to be sent to a parallel port or network port of the digital multi-function peripheral, a network setting key 123 for setting a condition for use of the digital multi-function peripheral as a network printer, and a system management storage/call key 124 for storing/calling conditions related to the present system management.

FIG. 24 depicts a network setting screen that appears when the network setting key 123 is pressed on the system management setting screen shown in FIG. 23.

The network setting screen displays an IP address setting key 131 for setting an IP address in a network. The network setting screen includes check boxes of NetWare effective setting 132, NetBEUI (BIOS Extended User Interface) effective setting 133, TCP/IP effective setting 134, and an EtherTalk effective setting 135, and an NIC reset key 136. An IP address can be set by checking the check box of TCP/IP effective setting 134 and using the IP address setting key 131.

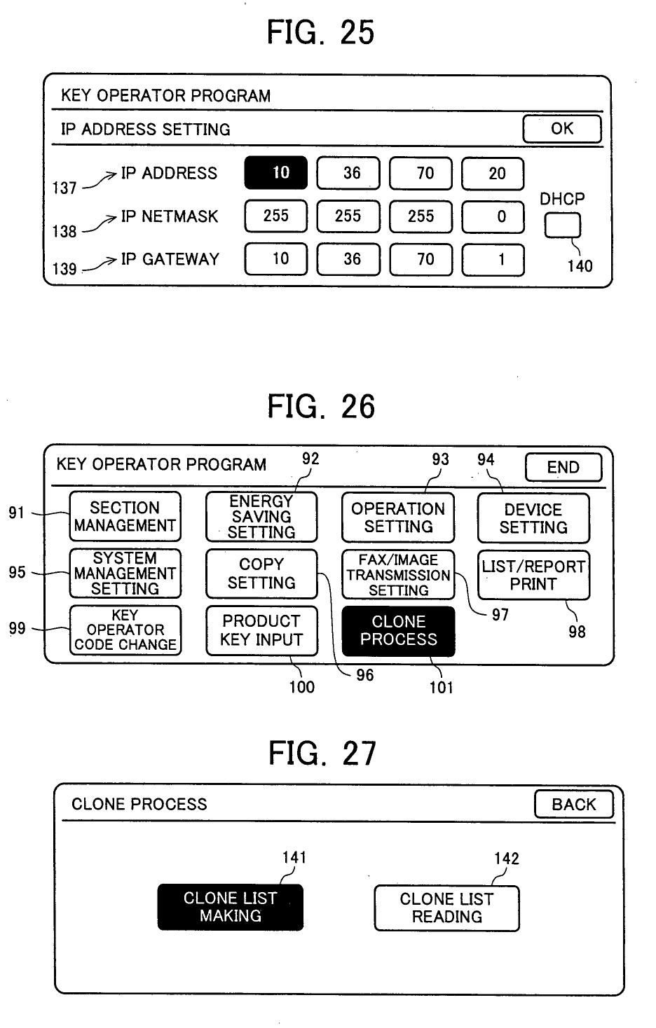

FIG. 25 depicts an IP address setting screen that appears when the IP address setting key 131 shown in FIG. 24 is pressed.

The IP address setting screen includes setting keys for an IP address 137, an IP netmask 138, and an IP gateway. 139. A DHCP (Dynamic Host Configuration Protocol) button 140 allows setting on effectiveness/invalidation of automatic obtainment of IP address setting.

As described above, according to the digital multi-function peripheral to which the present invention is applicable, setting of a variety of conditions is carried out for each of various functions incorporated into the digital multi-function peripheral.

Those setting data include setting data given by selection from selection items prepared for each function, and setting data given by user input, such as address data.

As described above, according to the embodiment of the present invention, the digital multi-function peripheral is provided with the function of forming both selected setting data and user input setting data into images on recording paper, etc. In addition, the digital multi-function peripheral is also capable of forming type data indicating the type of digital multi-function peripheral and log data indicating the process status of digital multi-function peripheral, into images. Thus, data cloning can be easily carried out by reading those data from recording paper bearing the data.

A specific example of the cloning process will be described referring to a screen example of the operation portion.

FIG. 26 depicts a state of selection of the clone process key 101 on the menu screen of the key operator program shown in FIG. 22. FIG. 27 depicts a clone process menu screen that appears when the clone process key 101 is pressed on the screen shown in FIG. 26.

The clone process menu screen shown in FIG. 27 can be brought into display by operation on the menu screen of the key operator program shown in FIG. 26. The clone process menu screen includes a clone list making key 141, and a clone list reading key 142.

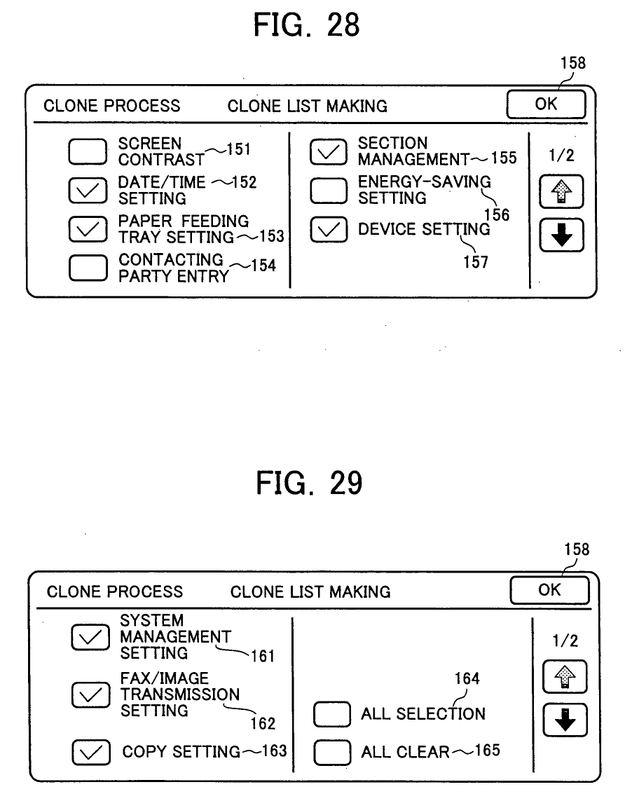

FIGS. 28 and 29 depict screens that appear when the clone list making key 141 is pressed on the clone process menu screen shown in FIG. 27, showing a clone process menu set on two screens.

On the clone list making process screens, a clone list can be made for each function incorporated into the digital multi-function peripheral 1. For example, on the screen shown in FIG. 28, check boxes are set for functions of the digital multi-function peripheral 1, functions including screen contrast 151, date/time setting 152, paper feeding tray setting 153, contacting party entry 154, section management 155, energy-saving setting 156, and device setting 157. The check boxes allow selection of each function.

On the screen shown in FIG. 29, check boxes are set for other functions of the digital multi-function peripheral 1, functions including system management setting 161, fax image transmission setting 162, copy setting 163, and check boxes for all selection 164 and all clear 165 are set. The check boxes allow selection of each function.

For example, the functions of screen contrast 151, date/time setting 152, paper feeding tray setting 153, and contacting party entry 154 can be set on the user setting screen shown in FIG. 12. The functions of section management 155, energy-saving setting 156, device setting 157, system management setting 161, fax/image transmission setting 162, copy setting 163 can be set on the key operator program menu shown in FIG. 22.

Only the setting data on a function with a checked check box can be formed into an image of coded information on a clone sheet, which will be described later. According to the present embodiment, therefore, setting data for setting various preset values related to functions of the digital multi-function peripheral can be selected for each function according to user input, and setting data related to a selected function can be formed into an image on a recording medium, such as recording paper.

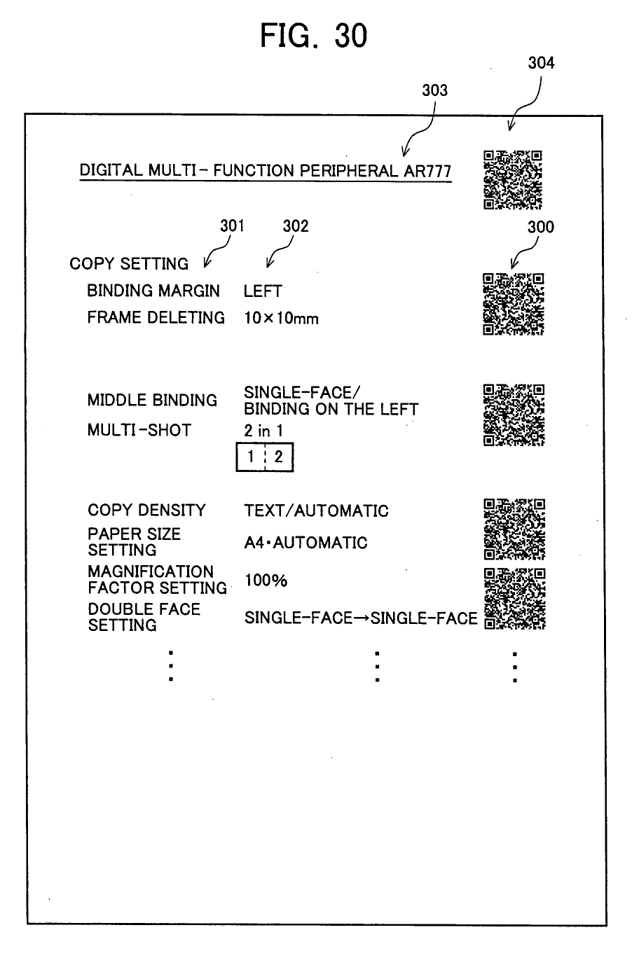

FIG. 30 is a schematic diagram of an example of a clone list made by a clone list making process.

In FIG. 30, each preset value related to copy setting is coded and formed into an image of two-dimensional code 300, and each setting item 301 and preset value 302, which is linked to each two-dimensional code 300, is printed as character information. For the formation of the two-dimensional code 300, for example, a QR code can apply.

On the clone list shown here, for example, the setting items 301 for copy setting, which include binding margin, frame deletion, middle binding, multi-shot, copy density, paper size setting, magnification factor setting, and double face copy setting, and the preset values 302 for the setting items 301 are printed as characters. In contrast, the two-dimensional codes 300, which are the coded form of the setting items and preset values, are formed into images. The two-dimensional codes 300 can contain preset values for a plurality of setting items according to the volume of information of the two-dimensional codes 300.

The clone list can include a two-dimensional code 304 that represents the type name of an apparatus for cloning, and character information 303 of the type name. Inclusion of type name information allows a determination on the appropriateness of cloning. Specifically, upon reading the two-dimensional code 304, the digital multi-function peripheral 1 is allowed to read only the two-dimensional coded information that is formed into an image by apparatuses identical in types. This prevents the digital multi-function peripheral 1 from mistakenly reading information of a multi-function peripheral of an inappropriate type for cloning.

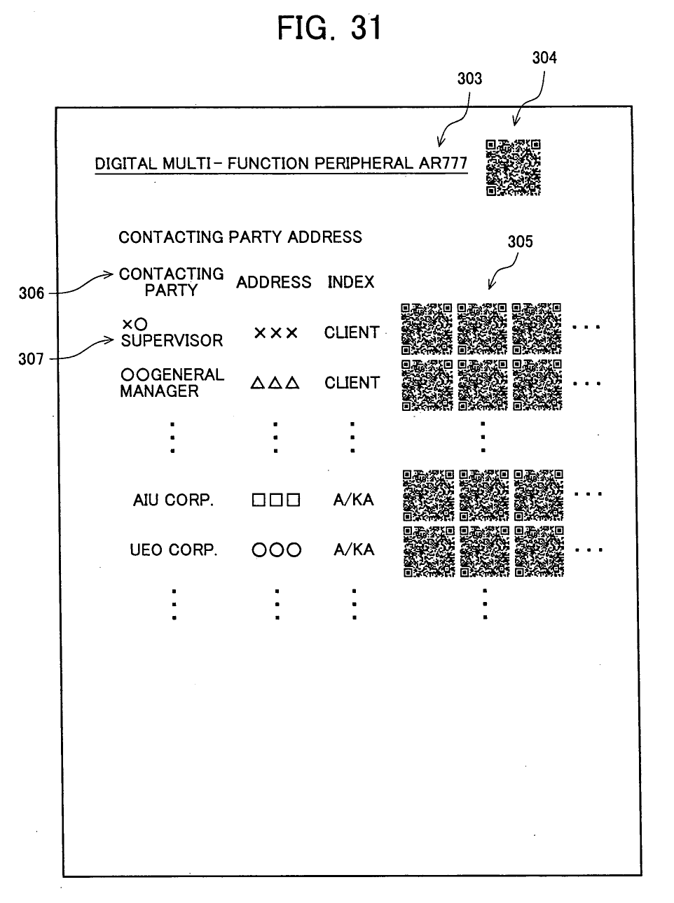

FIG. 31 is a schematic diagram of another example of a clone list made by the clone list making process.

On this clone list, contacting party address information, which is given as a user input preset value, is coded and formed into images of two-dimensional codes 305, and setting items 306 for the two-dimensional codes and preset values 307 for the setting items are printed as character information.

This clone list can also include the two-dimensional code 304 that represents the type name of an apparatus for cloning, and the character information 303 of the type name. The number of the two-dimensional codes can be determined properly according to the volume of information of the two-dimensional codes.

A coded image formed on a clone list is not limited to such an image of two-dimensional code as described above, but may be an image of a single-dimensional bar code. Another form of information may be employed if the information allows extraction of a preset value from a coded image.

A clone list bearing no two-dimensional codes but only the printed character information is also applicable. In this case, the character information is read to read setting data from the character information.

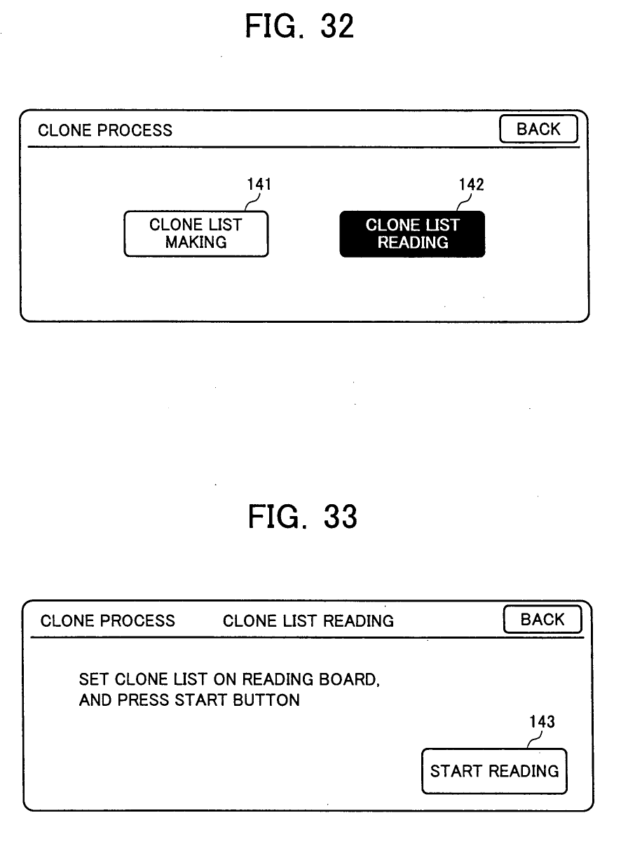

FIG. 32 depicts a state of selection of the clone list reading key 142 on the clone process menu screen shown in FIG. 27. FIG. 33 depicts a clone list reading start screen that appears when the clone list reading key 142 is brought into effect on the screen shown in FIG. 32.

Pressing a start reading key 143 shown in FIG. 33 starts reading of a clone list. As a result, setting data set for various functions, user input setting data, log data, etc., which are coded on the clone list, can be cloned on an apparatus that has read the clone list.

Type data included in the clone list enables the apparatus to determine on whether the clone list constitutes a clone sheet that is appropriate for execution of the clone process.

In this case, the apparatus control portion 14 of the digital multi-function peripheral 1 uses a coding program stored in the ROM to decode a coded image read by the image reading portion 11 and obtain setting data, log data, etc., and sets the obtained data for each function.

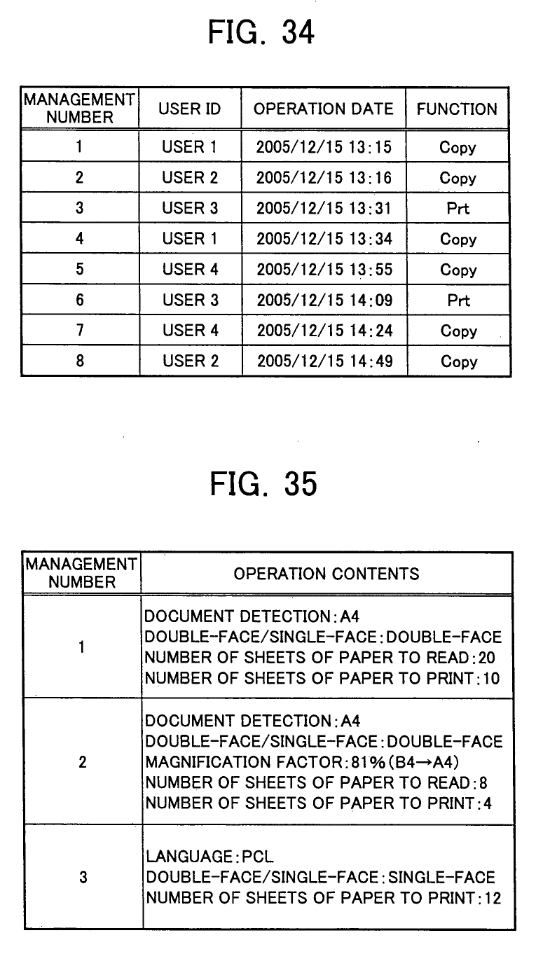

Each of FIGS. 34 and 35 depicts an example of log data of the digital multi-function peripheral 1. According to the present embodiment, log data of the digital multi-function peripheral 1 can be included in such a clone list as described above, where the log data can be coded and formed into an image of two-dimensional code, and character information of the log data can be printed in linkage to the two-dimensional code. To make the log data selectable as a subject for the clone list, for example, a log data check box is added to the screens shown in FIGS. 28 and 29.

Log data on a clone list may be formed into a coded image made of a code other than a two-dimensional code or just printed into character information, as in the case of the above setting data.

FIG. 34 depicts an example of a print job management list that is one piece of log information. FIG. 35 depicts an example of a table that records the operation contents of each job on the basis of the print job management list shown in FIG. 34. The management list and operation contents shown in FIGS. 34 and 35 may be put in the same table to be managed together.

As described above, log data indicating the process status of the digital multi-function peripheral 1 is formed into an image on a clone list. This allows another digital multi-function peripheral 1 reading the log data image to manage the log data as the original multi-function peripheral 1 does. The data-cloning multi-function peripheral, therefore, can check the process status of the original apparatus, reproducing a bug, abnormality, etc., in the original apparatus, on the data-cloning apparatus to be able to analyze a trouble, etc., in a flexible manner.

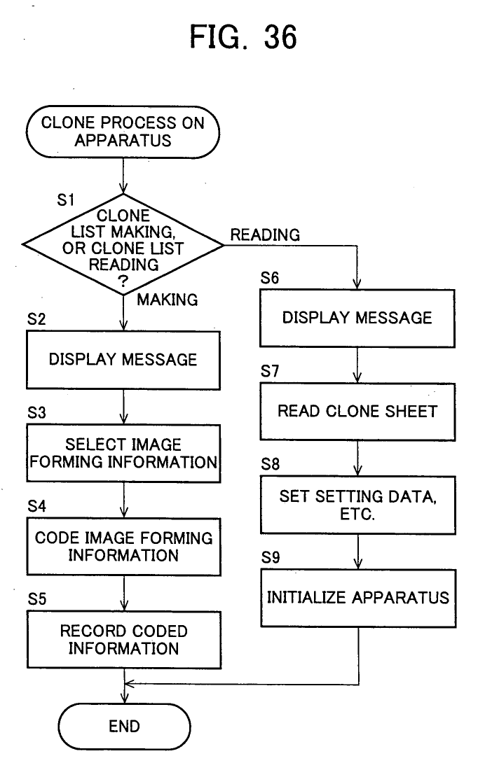

FIG. 36 is a flowchart for explaining an example of the clone process according to the present invention.

At the start of the clone process at an apparatus, the apparatus determines on which of the clone list making process and the clone list reading process to execute (step S1). In this case, the apparatus determines on which of the clone list making process and the clone list reading process to execute, for example, according to a result of selection on the clone process menu screen shown in FIG. 32.

When the clone list making process is to be executed, a clone list making message is displayed (step S2). For example, as shown in FIGS. 28 and 29, the selection screens for functions that can be listed on a clone list are displayed.

Then, image forming information, such as various setting data and log data to be listed on the clone list, is selected from the selection screens (step S3).

The image forming information composed of the selected setting data and log data is coded (step S4), and the coded information is formed into images on recording paper, etc. (step S5). Hence a clone sheet is produced, where the coded information for each function is formed into images, as shown in FIGS. 30 and 31.

When the clone list reading process is to be executed at step S1, a clone list reading message is displayed (step S6). For example, the clone process reading start screen shown in FIG. 33 is displayed.

When the reading start key 143 is pressed on the start screen, the clone sheet reading process is executed (step S7). For example, the image reading portion 11 of the digital multi-function peripheral reads coded information formed into images on the clone sheet.

The read coded information is then decoded to obtain setting data, log data, etc. The obtained data are set on the apparatus (step S8), which is then initialized (step S9). In this manner, the setting data and log information of an apparatus making the clone sheet can be cloned easily by using the setting data and log information read from the clone sheet.

The present invention offers the following effects.

According to the present invention, various preset values for each function of an apparatus and user input preset values can be cloned surely and easily between apparatuses without a need of interconnecting the apparatuses via an interface.

According to the present invention, type information of an apparatus is included in information to be cloned to prevent the apparatus from mistakenly reading data that cannot be set from an apparatus of different type. This allows the apparatus to carry out efficient and highly reliable cloning.

According to the present invention, log information indicating the process status of an apparatus is included in information to be cloned to allow a data-cloning apparatus to reproduce a bug and/or abnormality in the original apparatus and becomes capable of flexible trouble analysis.

According to the present invention, only the preset value for a desired function can be selectively cloned out of various preset values for various functions.

1. An image processing apparatus comprising an image reading portion that reads an image recorded on a recording medium and an image forming portion that forms an image on a recording medium, wherein
the image processing apparatus further includes a setting data selecting portion that selects setting data for each function according to user input, the setting data being used to set various preset values related to functions of the image processing apparatus, and wherein
the image forming portion forms setting data selected by the setting data selecting portion into an image on a recording medium.

2. The image processing apparatus of claim 1, further including a data setting portion that clones a preset value by setting the setting data read by the image reading portion on the image processing apparatus.

3. The image processing apparatus of claim 1, wherein
the setting data include setting data selected out of prepared selection items and setting data set by user input.

4. The image processing apparatus of claim 1, wherein
the image forming portion forms type data of the image processing apparatus, together with the setting data, into an image, the type data being used to determine on appropriateness of cloning.

5. The image processing apparatus of claim 1, wherein
the image forming portion forms log data, together with the setting data, into an image, the log data indicating a process status of the image processing apparatus.

6. The image processing apparatus of any one of claims 1 to 3, wherein
the image forming portion forms any one or plurality of the setting data, type data, and log data into an image of coded information, the type data being used to determine on appropriateness of cloning a preset value, and the log data indicating a process status of the image processing apparatus.

7. The image processing apparatus of claims 6, wherein
the image forming portion forms any one or plurality of the setting data, the type data, and the log data into an image of character information.

8. A cloning method for cloning setting data between image processing apparatuses each having an image forming portion that forms an image on a recording medium according to an image read by an image reading portion, the setting data being used to set various preset values related to functions of the image processing apparatus, the method comprising:
a setting data selecting step of selecting the setting data for each function of the image processing apparatus according to user input; and
an image forming step of forming the setting data selected at the setting data selecting step into an image on a recording medium.

9. The cloning method of claim 8, further including a cloning step of setting the setting data read by the image forming portion on the image processing apparatus to execute cloning.

10. The cloning method of claim 8, wherein
the setting data include setting data selected out of prepared selection items and setting data set by user input.

11. The cloning method of claim 8, wherein
at the image forming step, type data of the image processing apparatus, together with the setting data, is formed into an image, the type data being used to determine on appropriateness of cloning.

12. The cloning method of claim 8, wherein
at the image forming step, log data, together with the setting data, is formed into an image, the log data indicating a process status of the image processing apparatus.

13. The cloning method of anyone of claims 8 to 10, wherein
at the image forming step, any one or plurality of the setting data, type data of the image processing apparatus, and log data is or are formed into an image of coded information, the type data being used to determine on appropriateness of cloning a preset value, and the log data indicating a process status of the image processing apparatus.

14. The cloning method of claim 13, wherein
at the image forming step, any one or plurality of the setting data, the type data, and the log data is or are formed into an image of character information.
